(19) United States
(12) Patent Application Publication
(10) Pub. No.: US 2015/0211269 A1
(43) Pub. Date: Jul. 30, 2015

(54) Doorstop Assembly

(71) Applicants: Dawn Gehrke, Castlewood, SD (US); Lyle Gehrke, Castlewood, SD (US)

(72) Inventors: Dawn Gehrke, Castlewood, SD (US); Lyle Gehrke, Castlewood, SD (US)

(21) Appl. No.: 14/165,783

(22) Filed: Jan. 28, 2014

(51) Int. Cl. E05C 17/48

(52) U.S. Cl. CPC E05C 17/48

(57) ABSTRACT

A doorstop assembly includes a sleeve having a top end and an opened bottom end. The sleeve has a longitudinal pin groove extending therethrough between the top and bottom ends. At least one mount is attached to the sleeve and mounts the sleeve to a door of a trailer. A rod is elongated and has an upper end a lower end. The rod is positioned within an interior of the sleeve and is slidably extendable outwardly of the bottom end. The rod terminates in a point to engage a ground surface. A pin is coupled to and extends laterally away from the rod proximate the top end of the rod. The pin is movable along the longitudinal pin groove to extend the rod outwardly of the bottom end to a deployed position engaging the ground surface.

### BACKGROUND OF THE DISCLOSURE

### Field of the Disclosure

The disclosure relates to doorstop devices and more particularly pertains to a new doorstop device for mounting on a door of a trailer so the door is retained at a selected position.

### SUMMARY OF THE DISCLOSURE

An embodiment of the disclosure meets the needs presented above by generally comprising a sleeve that is elongated and has a top end and a bottom end and wherein the bottom end is open. The sleeve has a longitudinal pin groove extending therethrough and extending between the top and bottom ends. The sleeve has a vertical length from the top end to the bottom end greater than 24.0 inches. At least one mount is attached to the sleeve and is configured to mount the sleeve to a door of a trailer. A rod is elongated and has an upper end a lower end. The rod is positioned within an interior of the sleeve wherein the rod is slidably extendable outwardly of the bottom end of the sleeve. The rod terminates in a point for engaging a ground surface. The rod has a length from the upper end to the lower end greater than 24.0 inches. A pin is coupled to and extends laterally away from the rod proximate the top end of the rod. The pin is movable along the longitudinal pin groove to extend the rod outwardly of the bottom end to a deployed position engaging the ground surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are speared out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a doorstop assembly according to an embodiment of the disclosure.

FIG. 2 is a perspective view of an embodiment of the disclosure.

FIG. 3 is a front view of an embodiment of the disclosure.

FIG. 4 is a right side view of an embodiment of the disclosure.

FIG. 5 is a cross sectional view taken along line 5-5 of FIG. 3 of an embodiment of the disclosure.

FIG. 6 is an in-use view of an embodiment of the disclosure.

### DESCRIPTION OF THE PREFERRED EMBODIMENT

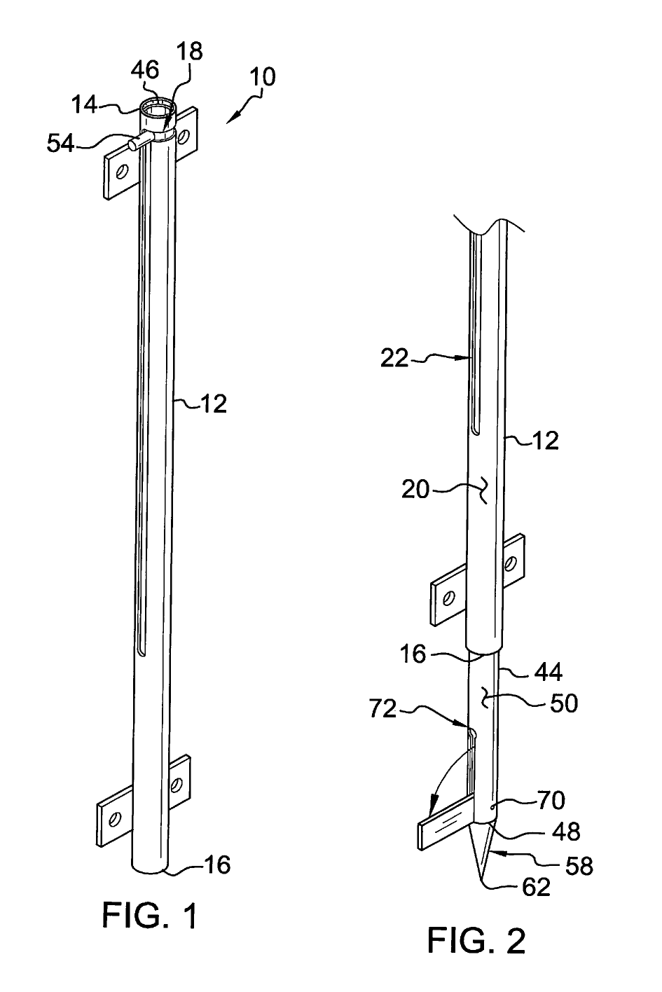

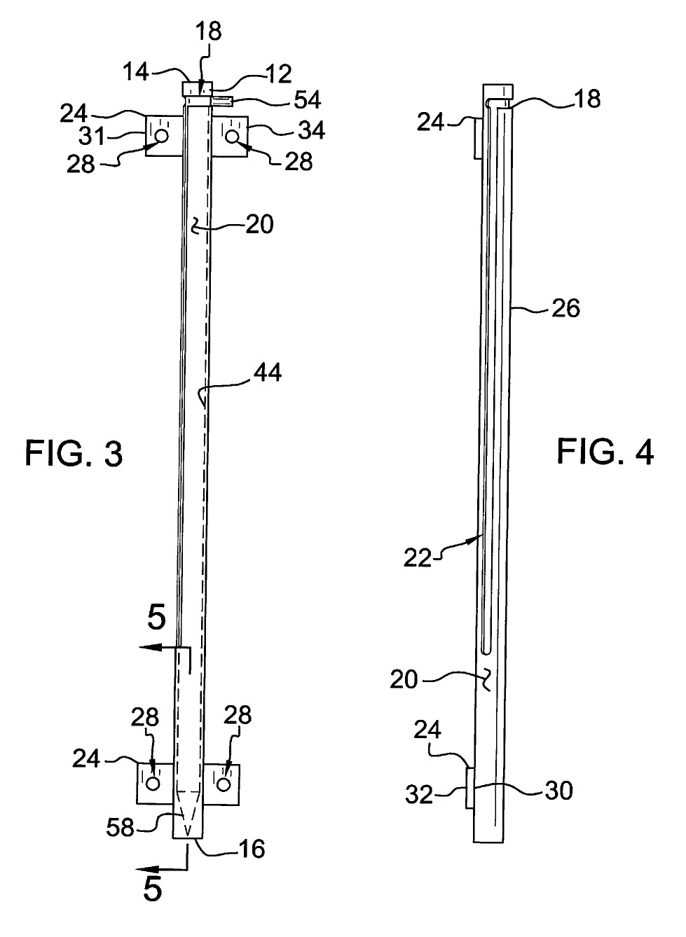

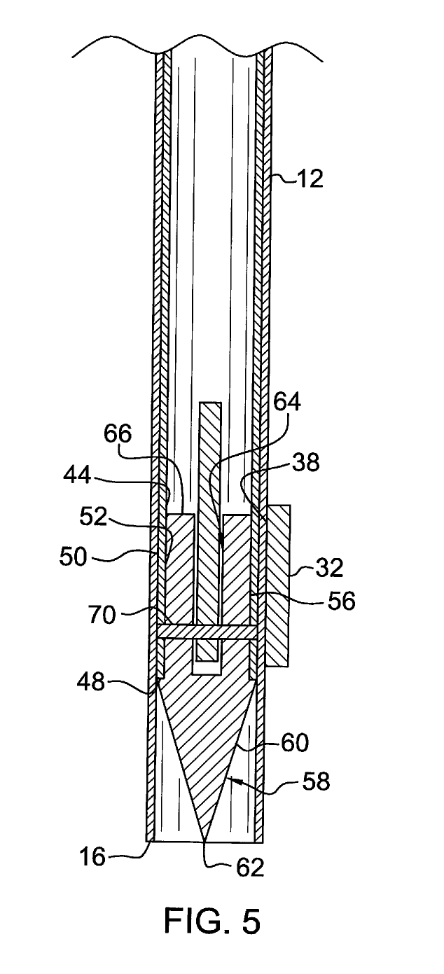

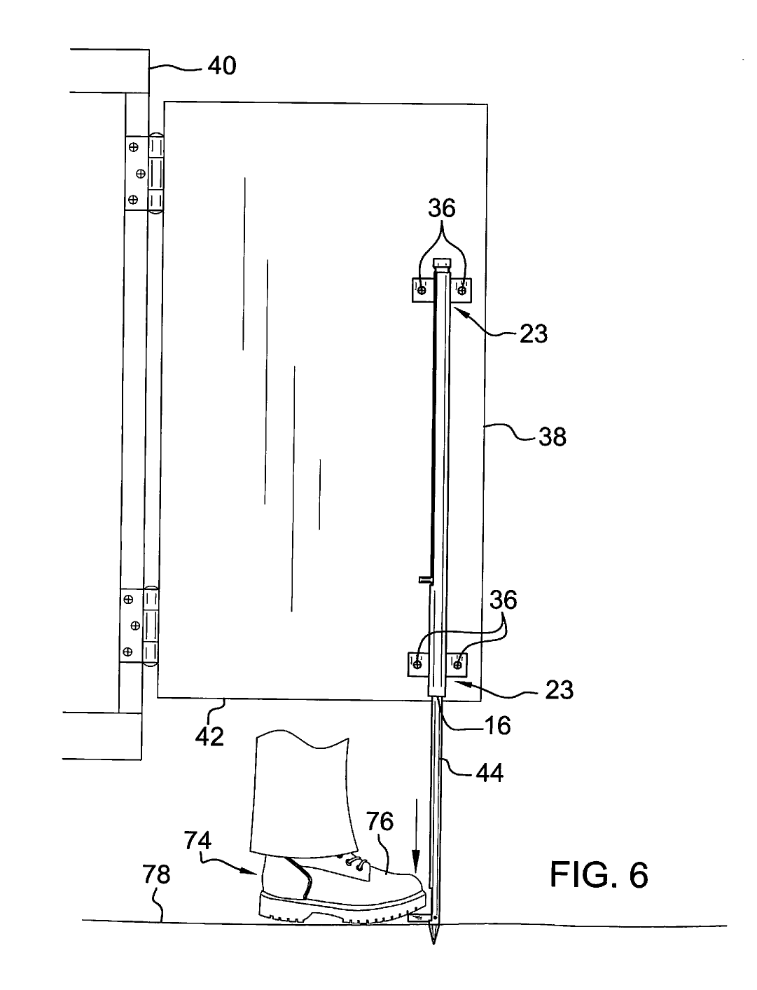

With reference now to the drawings, and in particular to FIGS. 1 through 6 thereof, a new doorstop device embodying the principles and concepts of an embodiment of the disclosure and generally designated by the reference numeral 10 will be described.

As best illustrated in FIGS. 1 through 6, the doorstop assembly 10 generally comprises an sleeve 12 elongated along an line extending through a top end 14 and a bottom end 16 of the sleeve 12. The bottom end 16 of the sleeve 12 is open. The sleeve 12 may have a length greater and 24.0 inches and generally between 24.0 inches and 48.0 inches. Additionally, the sleeve 12 may have a diameter between 0.5 inches and 2.0 inches. Finally, the sleeve 12 may be comprised of a rigid material such as steel, plastic or other similar material. The sleeve 12 has a lateral pin groove 18 extending therethrough such that it extends through an outside surface 20 of the sleeve 12. The lateral pin groove 18 extends laterally along the outside surface 20 of the sleeve 12. The lateral groove 18 may have a length between 1.0 in and 3.0 in. Continuing, the sleeve 12 has a longitudinal pin groove 22 extending through the outside surface 20 of the sleeve 12. The longitudinal pin groove 22 extends between the lateral pin groove 18 and an area proximate the bottom end 16 of the sleeve 12. The lateral 18 and longitudinal 22 pin grooves intersect each other. Finally, the longitudinal pin groove 22 may have a length between 18 inches and 32 inches.

One or more mounts 23 are attached to the sleeve 12 to facilitate attachment of the sleeve 12 to an inside surface of a trailer 40 door 38. The mounts 23 may include a pair of tabs 24 coupled to a back side 26 of the sleeve 12. Each of the pair of tabs 24 is positioned proximate an associated one of the top end 14 and the bottom end 16 of the sleeve 12. Each of the pair of tabs 24 has a pair of fastener apertures 28 extending through a front side 30 and a back side 32 thereof. Additionally, each of the pair of fastener apertures 28 is positioned proximate an associated one of a first lateral edge 31 and a second lateral edge 34 of each of the pair of tabs 24. Finally, each of the pair of tabs 24 may have a length between 3.0 in and 5.0 in. The mounts 23 further include a plurality of fasteners 36 with each fastener 36 extending through one of said fastener apertures 28 to engages the door, the plurality of fasteners 36 retain the sleeve 12 on the door 38. The door 38 may be coupled to the trailer 40 of any conventional design but which may in particular include a horse trailer and will more particularly include a door 38 having a bottom edge 42 which is generally greater than 12 inches from a ground surface when the door 38 is in an open position. The bottom end 16 of the sleeve 12 is positioned proximate the bottom edge 42 of the door 38.

A rod 44 is elongated along a line extending through its upper end 46 and a lower end 48. The rod 44 is positioned within an interior of the sleeve 12 so that the rod 44 is slidably and movably positioned within the sleeve 12. The rod 44 may have a length greater than 24.0 inches and generally between 24.0 inches and 40.0 inches and have a diameter between 0.25 inches and 2.0 inches. The rod 44 may be tubular and therefore hollow and further the upper 46 and lower 48 ends may be open. A pin 54 is coupled to and extends laterally away from the rod 44. The pin 54 is positioned proximate the upper end 46 of the rod 44. The pin 54 extends outwardly from the lateral pin groove 18 in the sleeve 12 so the rod 44 is retained in a stored position preventing vertical movement of the rod 44. The rod 44 may be completely contained in the sleeve 12 when the rod 44 is in the stored position. The pin 54 movable toward the longitudinal pin groove 22 such that the pin 54 moves downwardly in the longitudinal pin groove 22 to extend the rod downwardly from the sleeve 12 to a deployed position. Moreover, the rod 44 extends downwardly from the bottom end 16 of the sleeve 12 when the rod 44 is in the deployed position. The pin 54 may have a length between 2.0 in and 4.0 in.

With respect to the pin 54, it is noted that the sleeve has a distal edge with respect to the inner surface of the door 38 and that a plane may be defined which includes the distal edge and wherein the plane is parallel to the inner surface of the door 38. The pin 54 is positioned in a space between the plane and the inner surface when the rod 44 is in the stored position and the pin 54 is in the lateral pin groove 18. The lateral pin groove 18 may extend at least 180° around the sleeve 12 and up to 270° around the sleeve 27. When the pin 54 is moved along the lateral pin groove 18 to the stored position, its longitudinal axis will be approximately parallel to a plane of the door 38 and could have its distal end, with respect to the rod 44, pointed toward the door 38. This will prevent the pin 54 from being knocked loose by animals positioned within the trailer 40. Additionally, the longitudinal pin groove may also be positioned between the plane and the inner surface of the door 38. Thus, the pin 54 will extend either parallel to the plane or towards the door 38 when the rod 44 is in the deployed position to prevent the pin 54 from being struck when the rod 44 is in the deployed position.

The rod 44 may include a pointed tip. If the rod 44 is hollow, it may comprise a pair of sections wherein the pointed tip may be formed by a spear 58 having a top portion 56 extending upwardly into the lower end 48 of the rod 44. The spear 58 is retained on the rod 44 by any conventional securing member. A bottom portion 60 of the spear 58 tapers to a point from the top portion 56 to a bottom end 62 of the spear 58. The top portion 56 of the spear 58 has a bar groove 64 extending downwardly into a top side 66 of the top portion 56 of the spear 58. A bar 68 is pivotally coupled to the spear 58. Additionally, the bar 68 is positioned within the bar groove 64. A hinge pin 70 extends through the rod 44, the top portion 56 of the spear 58 and the bar 68 so the bar 68 is retained on the spear 58. A vertical bar slot 72 extends through the outer surface 50 of the rod 44. The vertical bar slot 72 is positioned proximate the lower end 48 of the rod 44. The bar 68 is selectively positionable in a deployed position after the rod 44 is positioned in the deployed position. The bar 68 extends laterally through the vertical bar slot 72 when the bar 68 is in the deployed position so that it may be used for urging the bottom end 62 downwardly into a ground surface 78 such as dirt, gravel or other ground surface. It should be understood that if the rod 44 is of single piece construction, the bar 68 may be positioned within a slot in the rod 44 itself.

In use, the door 38 is positioned on an open position and the rod 44 is positioned in the deployed position. A user 74 places their foot 76 on the bar 68 after the bar 68 is positioned in the deployed position to urge the bar 68 downwardly so the spear 58 penetrates the ground surface 78. In this manner, the rod 44 retains the door 38 in its open condition at a selected location. The bar 68 and the rod 44 are both positioned in the stored position when the door 38 is to be closed. During high winds or if the trailer 40 is at an angle with respect to the ground surface 78, the rod 44 will prevent the door 38 from moving which could injury a person or animal or damage the trailer 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A doorstop assembly configured to be mounted on a door of a trailer wherein the door is retained at a selected position, said assembly comprising:
a sleeve being elongated and having a top end and a bottom end, said bottom end being open, said sleeve having a longitudinal pin groove extending therethrough and extending between said top and bottom ends, said sleeve having a vertical length from said top end to said bottom end greater than 24.0 inches;
at least one mount being attached to said sleeve and being configured to mount said sleeve to the door of the trailer;
a rod being elongated and having an upper end a lower end, said rod being positioned within an interior of said sleeve wherein said rod is slidably extendable outwardly of said bottom end of said sleeve, said rod terminating in a point for engaging a ground surface, said rod having a length from the upper end to the lower end greater than 24.0 inches; and
a pin coupled to and extending laterally away from said rod proximate said top end of said rod, said pin being movable along said longitudinal pin groove to extend said rod outwardly of said bottom end to a deployed position engaging the ground surface.

2. The doorstop assembly according to claim 1, wherein said sleeve has a lateral pin groove extending therethrough adjacent to said top end, said longitudinal pin groove being joined to said lateral pin groove to allow movement of said pin between said lateral pin groove and said longitudinal pin groove, said pin extending outwardly from said lateral pin groove to retain said rod in a stored position.

3. The doorstop assembly according to claim 1, wherein said mount includes:
a tab being coupled to a back side of said sleeve, said tab having a pair of fastener apertures extending through a front side and a back side of said tab; and
a plurality of fasteners, each of said fastener apertures having one of said fasteners extending therethrough and being configured to engage the door such that said sleeve is retained on the door such that said bottom end of said sleeve is positioned proximate a bottom edge of the door.

4. The doorstop assembly according to claim 3, wherein said mount includes a pair of mounts.

5. The doorstop assembly according to claim 1, wherein said mount includes a pair of mounts.

6. The doorstop assembly according to claim 1, wherein said rod further comprises:
said rod being substantially hollow and said lower end being open;
a spear having a top portion and a bottom portion, said top portion extending upwardly into said lower end of said rod, said spear being coupled to said rod, said bottom portion tapering inward from said top portion to said point such that said bottom portion has a conical shape;
said top portion of said spear having a bar groove extending downwardly into a top side of said top portion of said spear;
a bar pivotally coupled to said spear within said bar groove, said bar being selectively positioned in a deployed position extending outwardly away from said rod or in a stored position extending upwardly through said top side and towards said upper end, wherein said bar is configured for being stepped up to facilitate extension of said point in the ground surface.

7. A doorstop assembly configured to be mounted on a door of a trailer wherein the door is retained at a selected position, said assembly comprising:
a sleeve being elongated and having a top end and a bottom end, said bottom end being open, said sleeve having a lateral pin groove extending therethrough and a longitudinal pin groove extending therethrough, said lateral pin groove being positioned proximate said top end, said longitudinal pin groove being joined with said lateral pin groove and extending downwardly therefrom towards said bottom end, said sleeve having a vertical length from said top end to said bottom end greater than 24.0 inches;
a pair of mounts being attached to said sleeve and being configured to mount said sleeve to the door of the trailer, one of said mounts being positioned proximate said top end and one of said mounts being positioned proximate said bottom end, each of said mounts including:
a tab being coupled to a back side of said sleeve, said tab having a pair of fastener apertures extending through a front side and a back side of said tab;
a plurality of fasteners, each of said fastener apertures having one of said fasteners extending therethrough and being configured to engage the door such that said sleeve is retained on the door such that said bottom end of said sleeve is positioned proximate a bottom edge of the door;
a rod being elongated and having an upper end a lower end, said rod being positioned within an interior of said sleeve wherein said rod is slidably extendable outwardly of said bottom end of said sleeve, said rod terminating in a point for engaging a ground surface, said rod having a length from the upper end to the lower end greater than 24.0 inches, said rod further comprising:
said rod being substantially hollow and said lower end being open;
a spear having a top portion and a bottom portion, said top portion extending upwardly into said lower end of said rod, said spear being coupled to said rod, said bottom portion tapering inward from said top portion to said point such that said bottom portion has a conical shape;
said top portion of said spear having a bar groove extending downwardly into a top side of said top portion of said spear;
a bar pivotally coupled to said spear within said bar groove, said bar being selectively positioned in a deployed position extending outwardly away from said rod or in a stored position extending upwardly through said top side and towards said upper end, wherein said bar is configured for being stepped up to facilitate extension of said point in the ground surface; and
a pin coupled to and extending laterally away from said rod proximate said top end of said rod, said pin extending outwardly from said lateral pin groove in said sleeve wherein said rod is retained in a stored position, said pin being movable toward and downwardly along said longitudinal pin groove to extend said rod outwardly of said bottom end to a deployed position engaging the ground surface.

8. A trailer doorstop system comprising:
a trailer having a door hingedly coupled thereto, said door having an inside surface and a bottom edge, said inside surface facing an interior of said trailer when said door is in a closed position;
a sleeve being elongated and having a top end and a bottom end, said bottom end being open, said sleeve having a longitudinal pin groove extending therethrough and extending between said top and bottom ends, said sleeve having a vertical length from said top end to said bottom end greater than 24.0 inches;
said sleeve being attached to said inside surface of said door such that said sleeve is vertically oriented and said bottom end is proximate to said bottom edge;
a rod being elongated and having an upper end a lower end, said rod being positioned within an interior of said sleeve wherein said rod is slidably extendable outwardly of said bottom end of said sleeve, said rod terminating in a point for engaging a ground surface, said rod having a length from the upper end to the lower end greater than 24.0 inches; and
a pin coupled to and extending laterally away from said rod proximate said top end of said rod, said pin being movable along said longitudinal pin groove to extend said rod outwardly of said bottom end to a deployed position engaging the ground surface.

9. The trailer doorstop system according to claim 8, wherein said sleeve has a lateral pin groove extending therethrough adjacent to said top end, said longitudinal pin groove being joined to said lateral pin groove to allow movement of said pin between said lateral pin groove and said longitudinal pin groove, said pin extending outwardly from said lateral pin groove to retain said rod in a stored position.

10. The trailer doorstop system according to claim 9, wherein said sleeve has a distal edge with respect to said inner surface of said door, wherein a plane is defined which includes said distal edge and which is parallel to said inner surface, said pin being positioned in a space between said plane and said inner surface when said rod is in the stored position and said pin is in said lateral pin groove.

11. The trailer doorstop system according to claim 10, wherein said longitudinal pin groove is positioned between said plane and said inner surface.

12. The trailer doorstop system according to claim 8, wherein said sleeve has a distal edge with respect to said inner surface of said door, wherein a plane is defined which includes said distal edge and which is parallel to said inner surface, said longitudinal pin grove is positioned in a space between said plane and said inner surface such that said pin extends either parallel to said plane or towards said door when said rod is in said deployed position.

13. The trailer doorstop system according to claim 8, wherein at least one mount is attached to said sleeve to mount said sleeve to said door of said trailer.

14. A trailer doorstop system according to claim 13, wherein said mount includes:
a tab being coupled to a back side of said sleeve, said tab having a pair of fastener apertures extending through a front side and a back side of said tab; and
a plurality of fasteners, each of said fastener apertures having one of said fasteners extending therethrough and into said door such that said sleeve is retained on the door such that said bottom end of said sleeve is positioned proximate a bottom edge of the door.

15. The trailer doorstop system according to claim 14, wherein said mount includes a pair of mounts.

16. The trailer doorstop system according to claim 13, wherein said mount includes a pair of mounts.

17. The trailer doorstop system according to claim 8, wherein said rod further comprises:
said rod being substantially hollow and said lower end being open;
a spear having a top portion and a bottom portion, said top portion extending upwardly into said lower end of said rod, said spear being coupled to said rod, said bottom portion tapering inward from said top portion to said point such that said bottom portion has a conical shape;
said top portion of said spear having a bar groove extending downwardly into a top side of said top portion of said spear;
a bar pivotally coupled to said spear within said bar groove, said bar being selectively positioned in a deployed position extending outwardly away from said rod or in a stored position extending upwardly through said top side and towards said upper end, wherein said bar is configured for being stepped up to facilitate extension of said point in the ground surface.

18. The trailer doorstop system according to claim 8, wherein said rod further comprises:
a bar being pivotally coupled to said bar adjacent to said lower end, said bar being selectively positioned in a deployed position extending outwardly away from said rod or in a stored position extending upwardly towards said upper end, wherein said bar is configured for being stepped up to facilitate extension of said point in the ground surface.

19. The trailer doorstop system according to claim 18, wherein said bar is positioned within said sleeve when said rod is in said stored position.
